(19) United States
(12) Patent Application Publication
(10) Pub. No.: US 2002/0132736 A1
(43) Pub. Date: Sep. 19, 2002

(54) Manufacturing method of active carbon from regenerated carbon powder

(76) Inventor: Mow-Jing Kuo, KaoShiung (TW)

Correspondence Address: Jason Z. LIN, 19597 Via Monte Drive, Sratoga, CA, 95070, US

(21) Appl. No.: 09/811,100

(22) Filed: Mar. 17, 2001

(51) Int. Cl. C01B 31/08

(52) U.S. Cl. 502/437; 423/460; 423/461; 201/22

(57) ABSTRACT

A method of manufacturing active carbon from regenerated carbon powder by splitting of waste tires including the following steps: (1) regenerating the carbon powder by splitting of the waste tires; (2) using a fluidized bed reactor for further carbonization and activation of the carbon powder; (3) cooling and collecting the carbon powder after reaction. The process of manufacturing promotes reaction and makes uniform heating, thus carbon powder can sufficiently contact steam to speed up and make uniform of the activation, and a complete reaction can be effected.

### FIELD OF THE INVENTION

The present invention is related to a method of manufacturing active carbon from regenerated carbon powder by splitting of waste tires, and especially to a method of manufacturing active carbon by using a fluidized bed reactor for uniform heating and promoting reaction.

### BACKGROUND OF THE INVENTION

In known recovering ways of waste tires, reusable metal is removed and the remaining rubber tires are discarded as garbage. This not only is wasteful, but also destructive to environment ecology by the rubber tires discarded for that they are difficult to deal with. In view of this, the present invention reuses carbon powder, which is made by regeneration of tires through splitting, in manufacturing active carbon which is required largely in amount in the markets today. This can increase the value of utility of waste tires, and also meets requirement of environmental conservation, and can be contribution to the balance of ecology.

Conventional methods of manufacturing active carbon are divided into two kinds, as is shown in FIG. 2, one is the rotary kiln reactor (A), material (carbon powder) is fed from the upper right side into the reactor, hot air needed by the carbonization enters the reactor from the left, then the reactor is rotated for reaction; after completion of the carbonization, activation is done. Steam required by the activation also enters the reactor from the left, and the reactor is maintained for rotation for the reaction until completion of the reaction. The product (active carbon) is collected at the lower left side of rollers.

The defect resided in the conventional methods of manufacturing active carbon is that, when in reaction by rotation, carbon powder is unable to completely contact the hot air and steam, effect of reaction thereby is inferior.

In view of this, the present invention makes a further improvement on the method of manufacturing active carbon from regenerated carbon powder by splitting of waste tires by using a fluidized bed reactor, in order to increase quality as well as effect of the product.

### SUMMARY OF THE INVENTION

The present invention is a method of manufacturing active carbon from regenerated carbon powder by splitting of waste tires, the main object thereof is to utilize regenerated carbon powder by splitting of waste tires for the process of manufacturing active carbon, this can increase recovering value of the waste tires and can get the object of environment protection.

The method of manufacturing active carbon from regenerated carbon powder by splitting of waste tires of the present invention has a secondary object of using a fluidized bed reactor for activation and carbonization to promote reaction and make uniform heating, thus the carbonization can be promoted and the carbon powder can sufficiently contact steam to speed up and make uniform of the activation, and the complete reaction can be effected.

The method of manufacturing active carbon from regenerated carbon powder by splitting of waste tires of the present invention includes the following steps: (1) providing regenerated carbon powder by splitting of waste tires; (2) using a fluidized bed reactor for carbonization and activation; (3) cooling and collecting. The process of manufacturing promotes reaction and makes uniform heating, thus carbon powder can sufficiently contact steam to speed up and make uniform of the activation, and the complete reaction can be effected.

The present invention will be apparent in its objects and functions after reading the detailed description of the preferred embodiment thereof in reference to the accompanying drawings.

### BRIEF DESCRIPTION OF THE DRAWINGS

FIG. 1 is a flow chart of the preferred embodiment of the present invention;

FIG. 2 is a schematic view of a conventional reactor.

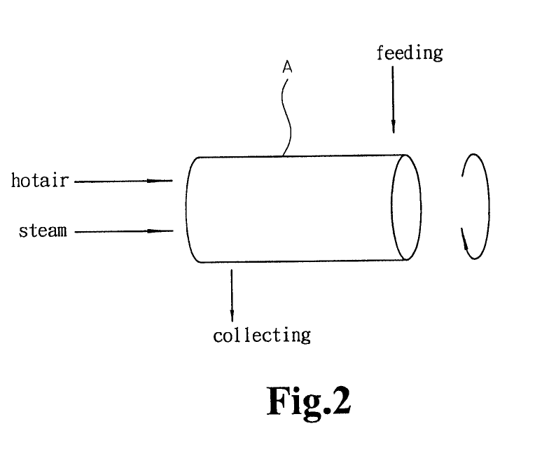

### DETAILED DESCRIPTION OF THE PREFERRED EMBODIMENT

The present invention is a method of manufacturing active carbon from regenerated carbon powder by splitting of waste tires, it includes the following steps:

(1) regenerating carbon powder by splitting of waste tires;

(2) using a fluidized bed reactor for further carbonization and activation of the carbon powder;

(3) cooling and collecting the carbon powder after reaction.

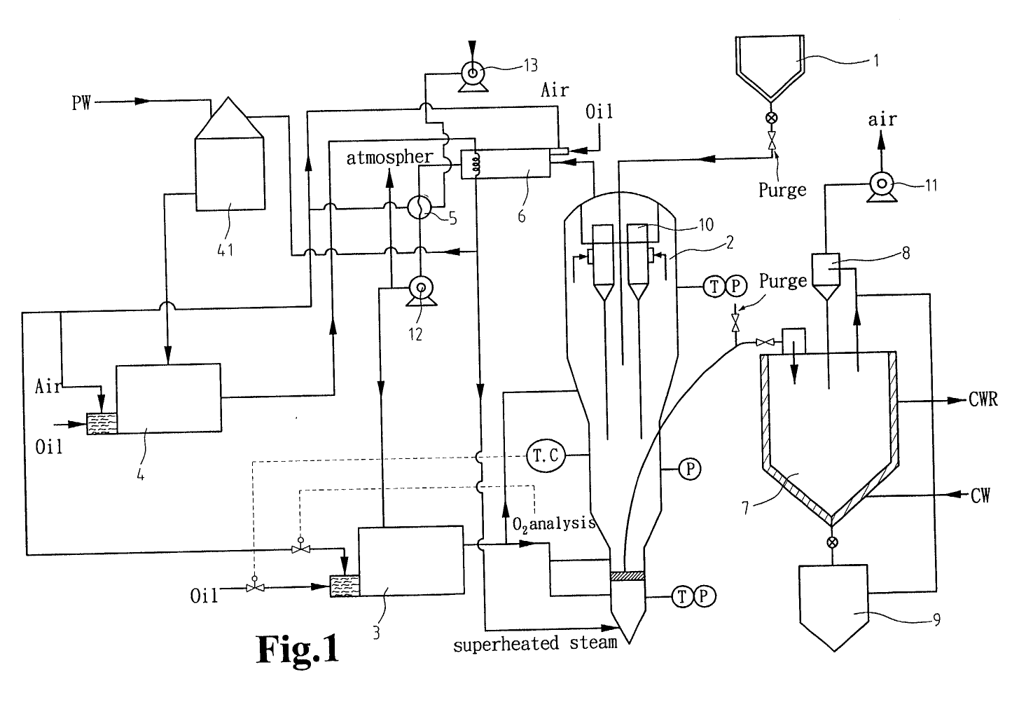

As shown in FIG. 1 which is a flow chart of the preferred embodiment of the present invention, wherein, the present invention provides a hot air furnace 3, hot air generated by the air furnace 3 enters a fluidized bed reactor 2 and then a post combustor 6 and an energy saver 5 for heating; and steam generated by a steam boiler 4 enters the post combustor 6. When the fluidized bed reactor 2 is in a stage of increasing temperature, steam passing through the post combustor 6 flows back to a water tank 41, water in the water tank 41 is heated by the steam. When temperature in the fluidized bed reactor 2 is increased to higher than 600° C., the regenerated carbon powder by splitting of waste tires is fed into a feeding tank 1, and the carbon powder is conveyed into the fluidized bed reactor 2 for carbonization and activation. The object of the carbonization is to remove the volatile organic substances and tar contained in the carbon powder, and when temperature is increased to higher than 800° C., more steam is put in to activate the carbon powder into active carbon. During the carbonization, organic substances such as VOC etc. are rapidly driven out of the carbon powder, then a cyclone separator 10 is used to separate the carbon powder and allows hot air to enter the post combustor 6; after all organic substances such as VOC etc. are burned out by the post combustor 6, and the steam conveyed into the post combustor 6 from the steam boiler 4 are heated by the hot air to form superheated steam which enters the fluidized bed reactor 2 for activation of the carbon powder. And a fan 13 draws fresh air into the energy saver 5 for heating, then the hot air is conveyed into the post combustor 6 and the air furnace 3 for combustion, partial hot air is sent out from by a circulation windmill 12; thereby partial hot air is circulated back to the air furnace 3 for reusing, and partial hot air is discharged to the atmosphere.

When temperature in the fluidized bed reactor 2 is increased to higher than 800-900° C., the activator steam can be added in to activate the carbon into active carbon, time for completion of activation is about 1-3 hours depending on temperature and amount of steam. Active carbon made by activation is drawn from the fluidized bed reactor 2 to a discharging buffering tank 7 by means of an air-drawing windmill 11. During operation of the air-drawing windmill 11, suspension or micro granules are simultaneously gotten through a micro granules collecting device 8 for collection to avoid the drawn air results air contamination after it is discharged to the atmosphere. At this time, hot air generated by the air furnace 3 and the superheated steam entering the fluidized bed reactor 2 are reduced to the least amount, in order that the active carbon can be drawn from the fluidized bed reactor 2 to the discharging buffering tank 7 to wait for cooling, after cooling, the active carbon is conveyed to a discharge tank 9 for packaging, or for shipping on a tank car.

The method of manufacturing active carbon from regenerated carbon powder by splitting of waste tires of the present invention uses a fluidized bed reactor for activation and carbonization to promote reaction and make uniform heating, thus the carbonization can be promoted and the carbon powder can sufficiently contact steam to speed up and make uniform of the activation, and a complete reaction can be effected.

In conclusion, the method of manufacturing active carbon from regenerated carbon powder by splitting of waste tires of the present invention not only has practical effect, but also is a novel invention never known in the markets, it is effective and improved.

The above statement is only for illustrating a preferred embodiment of the present invention, and not for giving any limitation to the scope of the present invention. All equivalent modifications and changes without departing from the spirit and principle of the present invention shall fall within the scope of the appended claims and are intended to form part of this invention. Having thus described my invention, what I claim as new and desire to be secured by Letters Patent of the United States are:

What is claimed is:

1. A method of manufacturing active carbon from regenerated carbon powder by splitting of waste tires, including the following steps:
(1) regenerating said carbon powder by splitting of said waste tires;
(2) using a fluidized bed reactor for further carbonization and activation of said carbon powder;
(3) cooling and collecting said carbon powder after reaction.

2. A method as in claim 1, wherein, temperature for said carbonization is between 800-900° C., time for completion of said activation is 1-3 hours.

3. A method as in claim 1, wherein, said activation is added in the process thereof with superheated steam.
